(19) United States
(12) Patent Application Publication
(10) Pub. No.: US 2022/0160002 A1
(43) Pub. Date: May 26, 2022

(54) NON-FRIED CHINESE NOODLES AND PRODUCTION METHOD THEREFOR

(71) Applicant: NISSIN FOODS HOLDINGS CO., LTD., Osaka-shi Osaka (JP)

(72) Inventors: Yuina KUSUDA, Osaka (JP); Kenta HAGIWARA, Osaka (JP)

(21) Appl. No.: 17/441,145

(22) PCT Filed: Aug. 3, 2020
(86) PCT No.: PCT/JP2020/029668

§ 371 Date: Sep. 20, 2021

(30) Foreign Application Priority Data
Aug. 28, 2019 (JP) 2019-156172

(51) Int. Cl. A23L 7/113; A23L 29/00; A23L 5/41

(52) U.S. Cl. CPC A23L 7/113; A23L 5/41; A23L 29/015

(57) ABSTRACT

The present invention addresses the subject of providing non-fried Chinese noodles with deterioration over time suppressed. The subject is solved by adding calcium monohydrogen phosphate hydrate to non-fried Chinese noodles to which sodium carbonate and/or potassium carbonate (kansui) has been added. The addition amount of the calcium monohydrogen phosphate hydrate relative to the addition amount of the sodium carbonate and/or potassium carbonate is preferably in the range of the following expression 1: 0.8X-2≤Y≤2X . . . (Expression 1) where X represents the addition amount (g) of the sodium carbonate and/or potassium carbonate based on 1 kg of a main raw material powder, and Y represents the addition amount (g) of the calcium monohydrogen phosphate hydrate based on 1 kg of the main raw material powder.

### TECHNICAL FIELD

The present invention relates to non-fried Chinese noodles and a production method therefor.

Instant noodles can be broadly classified into those for fried noodles and those for non-fried noodles conventionally. The fried noodles are noodles obtained by frying gelatinized noodles in oil at about 150° C. and drying the noodles. On the other hand, the non-fried noodles are noodles obtained by drying gelatinized noodles by a drying method other than a method of frying them in oil, and there are several drying methods, but common is a hot-air drying method including applying hot air to the noodles at about 70 to about 100° C. and an air velocity of about 5 m/s or less and thereby drying them for about 30 minutes to about 90 minutes.

In the non-fried noodles due to the hot-air drying, noodle strings are denser than those in the fried noodles, and the non-fried noodles are not easily discolored during the production and can contain a larger amount of kansui as compared with fried noodles, and especially in the case of Chinese noodles, authentic noodles having better flavor tend to be obtained. However, as the amount of kansui added is increased, unique flavor of Chinese noodles is strengthened, but the color of noodles easily changes to brown over time during storage, and there is also a problem that the noodle texture becomes a hard and brittle texture with hard surface and non-sticky core over time.

As methods to improve discoloration of the non-fried noodles, methods of Patent Literature 1 and Patent Literature 2 are known. In Patent Literature 1, as a method for suppressing “browning caused by kansui” that occurs in the steaming step, there is described a method including performing moisture supplying treatment for supplying moisture to noodle strings once or more to gelatinize the noodle strings and drying them during a step in the non-fried instant noodle production process, in which 1.2 to 2.5 wt % of kansui is added to a raw material powder to carry out noodle making and the resulting noodle strings are steamed.

In Patent Literature 2, for providing instant noodles which have strong kansui odor, rich flavor and suppressed browning of noodle strings, there are disclosed a production method for instant noodles, having 1) a step of obtaining noodle dough using cereal flour, a kansui raw material and an alcohol, 2) a step of subjecting the noodle dough to noodle making to obtain raw noodle strings and gelatinizing the raw noodle strings to obtain gelatinized noodles, and 3) a step of drying the gelatinized noodles, and a production method for instant noodles, having 1) a step of obtaining noodle dough using cereal flour and a kansui raw material, 2) a step of subjecting the noodle dough to noodle making to obtain raw noodle strings and supplying an alcohol to the raw noodle strings, 3) a step of gelatinizing the raw noodle strings supplied with an alcohol to obtain gelatinized noodles, and 4) a step of drying the gelatinized noodles.

In both the above literatures, however, prevention of discoloration during the production process is described, but prevention of discoloration over time during the storage is not described.

In Patent Literature 3 and Patent Literature 4, techniques using calcium monohydrogen phosphate for instant noodles are described, but they are each a technique to suppress acrylamide formation of fried noodles but not a technique for non-fried noodles, and the calcium monohydrogen phosphate is only given an example of an additive as a divalent cation.

### CITATION LIST

### Patent Literature

Patent Literature 1: Japanese Patent Laid-Open No. 2012-60998

Patent Literature 2: Japanese Patent Laid-Open No. 2017-29056

Patent Literature 3: Japanese Patent Laid-Open No. 2005-278448

Patent Literature 4: Japanese Patent Laid-Open No. 2005-21152

### SUMMARY OF INVENTION

### Technical Problem

It is an object of the present invention to provide non-fried Chinese noodles with deterioration over time suppressed.

### Solution to Problem

The present inventors have earnestly studied a method for suppressing deterioration during storage, and as a result, they have found the present invention by chance and have completed the present invention.

That is to say, provided are non-fried Chinese noodles comprising a noodle raw material, sodium carbonate and/or potassium carbonate, and calcium monohydrogen phosphate hydrate.

In the non-fried Chinese noodles according to the present invention, an addition amount of the sodium carbonate and/or potassium carbonate and an addition amount of the calcium monohydrogen phosphate hydrate preferably satisfy the following expression 1: 0.8X−2≤Y≤2X . . . (Expression 1) wherein X represents an addition amount (g) of the sodium carbonate and/or potassium carbonate based on 1 kg of a main raw material powder, and Y represents an addition amount (g) of the calcium monohydrogen phosphate hydrate based on 1 kg of a main raw material powder.

In the non-fried Chinese noodles according to the present invention, an addition amount of the sodium carbonate and/or potassium carbonate and an addition amount of the calcium monohydrogen phosphate hydrate preferably satisfy the following expression 2: 1.8X−7≤Y≤2X . . . (Expression 2) wherein X represents an addition amount (g) of the sodium carbonate and/or potassium carbonate based on 1 kg of a main raw material powder, and Y represents an addition amount (g) of the calcium monohydrogen phosphate hydrate based on 1 kg of a main raw material powder.

In the non-fried Chinese noodles according to the present invention, the addition amount of the sodium carbonate and/or potassium carbonate is preferably 5 to 15 g based on 1 kg of the main raw material powder.

A production method for non-fried Chinese noodles according to the present invention preferably comprises adding kneading water containing sodium carbonate and/or potassium carbonate dissolved therein to a powder obtained by adding calcium monohydrogen phosphate hydrate to a main raw material powder and subjecting them to powder mixing, kneading them with a mixer to prepare noodle dough, and then carrying out noodle making, steaming and drying, thereby producing non-fried Chinese noodles.

In the production method for non-fried Chinese noodles according to the present invention, an addition amount of the sodium carbonate and/or potassium carbonate and an addition amount of the calcium monohydrogen phosphate hydrate preferably satisfy the following expression 1: 0.8X=1≤Y≤2X . . . (Expression 1) wherein X represents an addition amount (g) of the sodium carbonate and/or potassium carbonate based on 1 kg of the main raw material powder, and Y represents an addition amount (g) of the calcium monohydrogen phosphate hydrate based on 1 kg of the main raw material powder.

In the production method for non-fried Chinese noodles according to the present invention, an addition amount of the calcium monohydrogen phosphate hydrate preferably satisfies the following expression 2: 1.8X−7≤Y≤2X . . . (Expression 2) wherein X represents an addition amount (g) of the sodium carbonate and/or potassium carbonate based on 1 kg of the main raw material powder, and Y represents an addition amount (g) of the calcium monohydrogen phosphate hydrate based on 1 kg of the main raw material powder.

In the production method for non-fried Chinese noodles according to the present invention, the addition amount of the sodium carbonate and/or potassium carbonate is preferably 5 to 15 g based on 1 kg of the main raw material powder.

### Advantageous Effect of Invention

By the present invention, non-fried Chinese noodles with deterioration over time suppressed can be provided.

### BRIEF DESCRIPTION OF DRAWING

FIG. 1 is a graph showing a relationship between the addition amount of kansui (sodium carbonate and potassium carbonate) and the addition amount of calcium monohydrogen phosphate hydrate in the non-fried Chinese noodles according to the present invention.

### DESCRIPTION OF EMBODIMENTS

The present invention will be described in detail hereinafter. However, the present invention is in no way limited by the following description.

1. Noodle Raw Material Formulation

For the non-fried Chinese noodles according to the present invention, raw materials of usual instant noodles can be used. That is to say, examples of the main raw material powders include cereal flours, such as wheat flour, barley flour and rice flour, and various starches, such as potato starch, tapioca starch, wheat starch and corn starch, and these may be used singly or may be used by mixing them. As the starches, raw starch, gelatinized starch, and modified starches, such as acetylated starch, etherified starch and crosslinked starch, can also be used.

In the present invention, to these main raw material powders can be added salt, alkaline agents such as kansui, various thickening agents, gluten, egg white, noodle quality modifiers, edible fat or oil, various pigments such as carotene pigment, preservatives, etc., which are generally used in the production of instant noodles. These may be added as powders together with the main raw material powder, or may be added by dissolving or suspending them in kneading water.

As kansui among these, sodium carbonate and/or potassium carbonate is used in the present invention. These materials are added by dissolving them in kneading water. Especially in the case of Chinese noodles, by kneading sodium carbonate or potassium carbonate with the main raw material powder such as wheat flour, unique flavor of Chinese noodles, namely so-called kansui odor, is developed. Sodium carbonate and potassium carbonate have almost the same effects in terms of kansui odor, and according to the noodle texture desired, they can be used singly or by mixing them. In the case of non-fried Chinese noodles, the amount of the sodium carbonate and/or potassium carbonate used is preferably in the range of 5 to 15 g based on 1 kg of the main raw material powder. When the amount thereof is in the above range, non-fried Chinese noodles having good unique flavor of Chinese noodles can be obtained. If the amount thereof is less than 5 g, the flavor of the non-fried Chinese noodles is weakened, but if the flavor does not matter, the addition amount may be less than 5 g. On the other hand, if the addition amount is larger than 15 g, not only is the flavor too strong but also discoloration becomes conspicuous during production, but if the flavor and the discoloration during production do not matter, the addition amount may be more than 15 g. The addition amount of the sodium carbonate and/or potassium carbonate may be set according to the product design desired.

In the present invention, calcium monohydrogen phosphate hydrate is used. Since the calcium monohydrogen phosphate hydrate is hardly dissolved in water, it is preferable to add a powder mixture of the calcium monohydrogen phosphate hydrate and the main raw material powder to the noodles. For the calcium monohydrogen phosphate, an anhydrate and a hydrate (dihydrate) exist, and although the cause is not clear, the anhydrate has no suppression effect on the deterioration over time, such as discoloration or texture change, and only the hydrate has a suppression effect. As a result of studies of various calcium salts, there are some having an effect of suppressing discoloration over time, but they affect the texture or the flavor such as kansui odor or cannot suppress texture deterioration over time, and calcium monohydrogen phosphate hydrate has a small impact on the texture or the flavor and is most effective for suppressing discoloration or texture deterioration over time.

The addition amount of the calcium monohydrogen phosphate hydrate relative to the addition amount of the sodium carbonate and/or potassium carbonate is preferably in the range of the following expression 1: 0.8X−2≤Y≤2X . . . (Expression 1) wherein X represents an addition amount (g) of the sodium carbonate and/or potassium carbonate based on 1 kg of the main raw material powder, and Y represents an addition amount (g) of the calcium monohydrogen phosphate hydrate based on 1 kg of the main raw material powder. If the addition amount (Y) of the calcium monohydrogen phosphate hydrate is less than 0.8X−2 (that is, Y<0.8X−2), a good effect of suppressing texture deterioration over time is not easily obtained. On the other hand, if the addition amount (Y) of the calcium monohydrogen phosphate hydrate is more than 2X (that is, Y>2X), the flavor such as kansui odor is weakened, and by adding calcium monohydrogen phosphate hydrate in a large amount, the texture is softened.

The addition amount of the calcium monohydrogen phosphate hydrate relative to the addition amount of the sodium carbonate and/or potassium carbonate is more preferably in the range of the following expression 2: 1.8X−7≤Y≤2X . . . (Expression 2) wherein X represents an addition amount (g) of the sodium carbonate and/or potassium carbonate based on 1 kg of the main raw material powder, and Y represents an addition amount (g) of the calcium monohydrogen phosphate hydrate based on 1 kg of the main raw material powder. By setting the addition amount of the calcium monohydrogen phosphate hydrate to Y≤1.8X−7, a good effect of suppressing discoloration over time can be obtained.

2. Kneading Step

The method for preparing noodle dough (dough) according to the present invention may be carried out in accordance with an ordinary method. That is to say, a powder containing a main raw material powder and calcium monohydrogen phosphate hydrate may be kneaded with kneading water containing sodium carbonate and/or potassium carbonate dissolved therein using a batch mixer, a flow jet mixer, a vacuum mixer, or the like in such a manner that they are homogeneously mixed, and thus, crumbly dough may be prepared.

3. Noodle Making Step

Subsequently, from the dough prepared, noodle strings are prepared. The preparation method may be carried out in accordance with an ordinary method. Examples of the methods include a method of extruding the dough using an extruder or the like to prepare noodle strings, and a method including preparing a crude noodle belt from the dough using rolls, then forming a noodle belt by compounding or the like, further rolling out the noodle belt more than once into a prescribed noodle belt thickness using rolls, and then cutting out the noodle belt with a cutting-out roll called a cutting blade to prepare noodle strings. When the noodle strings are prepared after the noodle belt is prepared, the rolling-out or the cutting-out may be carried out after a noodle belt is prepared using an extruder, or the rolling-out or the cutting-out may be carried out after a noodle belt having a multilayer structure is prepared by joining a plurality of noodle belts together. When an extruded noodle belt or extruded noodle strings are prepared using an extruder or the like, the preparation is preferably carried out under reduced pressure.

As the addition amount of the calcium monohydrogen phosphate hydrate is increased, the texture tends to become slightly hard, and in the case where a noodle belt having a multilayer structure is prepared, the calcium monohydrogen phosphate hydrate is preferably added to the inner layer in a large amount because if it is added to the outer layer in a large amount, the surface hardness becomes conspicuous. In this case, even if the calcium monohydrogen phosphate hydrate is added to the inner layer only, there is almost no difference in the suppression of discoloration or deterioration of texture over time when compared with the case where the calcium monohydrogen phosphate hydrate is homogeneously added to the whole noodles.

4. Steaming Step

The noodle strings obtained in the noodle making step are steamed by an ordinary method to gelatinize the noodle strings. As the steaming conditions, preferred conditions vary depending on the type of the noodles and the thickness of the noodles, and therefore, preferred conditions may be appropriately set according to the desired texture. For the steaming method, not only boiling or heating with saturated water vapor but also heating with superheated water vapor can be carried out, and a moisture supplying step due to showering, dipping or the like can be combined. If necessary, the noodles cooked can be dipped in a seasoning liquid, or a loosening agent can be added thereto.

5. Drying Step

The noodle strings are cut into one meal amount, weighed, packed in a drying container called a retainer, and dried. The drying method is not particularly limited as long as it is a method other than fry drying, and drying may be carried out using drying techniques such as hot-air drying, microwave drying and vacuum-freeze-drying. Among these, hot-air drying is commonly used as the drying method for non-fried noodles, and in the case of the hot-air drying, drying may be carried out using hot air at 60 to 150° C. The drying step may be carried out by combining a plurality of conditions, and drying may be carried out in such a manner that the moisture content after drying reduces to 14.5 wt % or less, and preferably 6 to 12 wt %. For example, in the hot-air drying, drying is generally carried out using hot air at about 50 to about 100° C. and an air velocity of 1 to 5 m/s until the moisture content reduces to about 8 to about 12 wt %, but after the drying is carried out as above, puffing treatment can also be carried out by further applying hot air at about 105 to about 130° C. and an air velocity of 30 to 70 m/s or applying hot air subjected to humidity conditioning with steam, to the dried noodles for a short time.

6. Others

After the dried non-fried Chinese noodles are cooled, they may be placed in a cup together with soup and ingredients and covered with a lid to prepare instant cup noodles, or may be placed in a plastic bag together with soup to prepare instant bag noodles.

Hereinafter, the present embodiment will be described in more detail with reference to examples.

### EXAMPLES

<Experiment 1> Screening Test

### Test Examples 1-1 to 1-13

A main raw material powder of 1 kg composed of 900 g of all-purpose flour and 100 g of acetylated tapioca starch, and 30 g of a calcium salt for screening of each of Test Examples 1-2 to 1-13 were subjected to powder mixing (Test Example 1-1 was a test for comparison, in which calcium salt was not added; calcium salts in Test Examples 1-2 to 1-13: see Table 1), then to the resulting powder mixture, kneading water obtained by dissolving 15 g of salt and 20 g of a kansui preparation (sodium carbonate 6:potassium carbonate 4) in 400 g of water was added, and they were kneaded with a normal pressure mixer for 15 minutes, thereby preparing a dough.

The dough prepared was compounded to prepare a noodle belt, and the noodle belt was aged for 15 minutes, then rolled out to 1.1 mm by a rolling method and cut with a No. 16 square roll cutting blade, thereby preparing noodle strings.

Subsequently, the noodle strings prepared were steamed for 1 minute 40 seconds in a steam chamber adjusted in such a manner that the flow rate of saturated steam became 240 kg/h, then dipped for 5 seconds in a liquid seasoning containing 10 g of salt and 5 g of gum arabic per liter dissolved therein, and cut to about 30 cm, and thereafter, noodles of 140 g for one meal were packed in a stainless steel drying container (retainer) in approximately deep dish shape.

The noodles packed in the retainer were dried with hot air at 70° C. and an air velocity of 3 m/s for 60 minutes.

The dried non-fried Chinese noodles were placed in an expanded polystyrene cup, and the cup was sealed with a lid made of paper covered with aluminum, thereby preparing a test sample (instant cup noodles). As test samples, a sample stored in a 4° C. refrigerator immediately after the preparation (before forced deterioration) and a sample subjected to forced deterioration under the constant temperature and humidity conditions of 40° C. and a humidity of 75% for 2 weeks (after forced deterioration) were prepared, and they were each evaluated by confirming sample appearance and texture. By the forced deterioration under the constant temperature and humidity conditions of 40° C. and a humidity of 75% for 2 weeks, deterioration conditions the same as those of storage at ordinary temperature of 25° C. for 4 months are provided. Since the present experiment was a screening test, kansui (sodium carbonate and calcium carbonate) was added in a larger amount than the amount generally added to non-fried Chinese noodles, and screening of the test sample was carried out under the conditions accelerating deterioration.

In the evaluation of the change of color of the test sample, a difference in color between the samples before forced deterioration and after forced deterioration was visually evaluated, and the deterioration level of Test Example 1-1 was used as a reference. A sample in which color deterioration was suppressed and the color was very good was evaluated as Excellent, a sample in which discoloration was observed but suppressed and the color was generally good was evaluated as Good, a sample in which discoloration was suppressed more than that in Test Example 1-1 but the suppression was insufficient was evaluated as Fair, and a sample in which discoloration was nearly equal to that in Test Example 1-1 was evaluated as Poor.

To evaluate the texture and flavor of the test sample, into respective samples before forced deterioration and after forced deterioration, 480 ml of boiling water was introduced, the samples were cooked for 5 minutes, then liquid soup for Soy Sauce Ramen was added, and they were eaten and evaluated. In the evaluation of the texture and flavor of the test sample before forced deterioration, the impact of each material was evaluated by using the Test Example 1-1 as a reference. A sample whose texture and flavor were equal to those of Test Example 1-1 was evaluated as Excellent, a sample whose texture and flavor were slightly different from those of Test Example 1-1 but were good was evaluated as Good, a sample whose texture and flavor were different from those of Test Example 1 and were inferior was evaluated as Fair, and a sample whose texture and flavor were different from those of Test Example 1-1 and were markedly inferior was evaluated as Poor. To evaluate the change of texture over time, the deterioration level (surface hardening or hard and brittle texture) of Test Example 1-1 due to change over time was used as a reference. A sample in which there was no deterioration and the texture was very good was evaluated as Excellent, a sample in which deterioration was observed but was suppressed and the texture was generally good was evaluated as Good, a sample in which deterioration was suppressed more than that in Test Example 1-1 but the suppression was insufficient was evaluated as Fair, and a sample in which the deterioration state was nearly equal to that in Test Example 1-1 was evaluated as Poor.

The evaluation results of Experiment 1 are set forth in the following Table 1.

TABLE 1

| | | Flavor | Texture | | | |
|---|---|---|---|---|---|---|
| | | before | before | | Texture | |
| Test | Material for | forced | forced | Discoloration | deterioration | |
| Example | screening | deterioration | deterioration | suppression | suppression | Comment |
| 1-1 | None | Reference | Reference | Reference | Reference | Reference containing no material for screening. For |
| | | (Excellent) | (Excellent) | (Poor) | (Poor) | accelerating deterioration over time, kansui is added in a larger |
| | | | | | | amount than usual, so that kansui odor is considerably strong, |
| | | | | | | and elasticity is considerably high. Discoloration (browning) |
| | | | | | | after forced deterioration is serious, and texture is hard and |
| | | | | | | brittle texture with hard surface and non-sticky core. |
| 1-2 | Calcium | Good | Good | Poor | Poor | Impact on texture and flavor before forced deterioration is |
| | carbonate | | | | | small, and texture and flavor are generally good, but |
| | | | | | | deterioration over time cannot be suppressed. |
| 1-3 | Calcium | Poor | Poor | Excellent | Poor | Discoloration over time can be suppressed, but impact on |
| | chloride | | | | | texture and flavor is strong, and flavor and texture before |
| | | | | | | forced deterioration are bad. Change of texture over time |
| | | | | | | cannot be evaluated because texture is inherently bad. |
| 1-4 | Calcined | Good | Excellent | Good | Poor | There is a small impact on texture, but flavor is felt slightly |
| | calcium | | | | | different from kansui odor. There is the effect of suppressing |
| | | | | | | discoloration over time, but texture deterioration cannot be |
| | | | | | | suppressed. |
| 1-5 | Calcium | Good | Good | Good | Poor | Impact on texture and flavor is small, and texture and flavor |
| | sulfate | | | | | are generally good. There is effect of suppressing |
| | | | | | | discoloration over time, but there is no effect of |
| | | | | | | suppressing texture deterioration over time. |
| 1-6 | Calcium | Poor | Good | Good | Good | There is the effect of suppressing deterioration over time, and |
| | hydroxide | | | | | impact on texture is small, but flavor is markedly bad. |
| 1-7 | Calcium | Good | Excellent | Fair | Fair | Impact of the anhydrous monohydrogen form on texture is |
| | monohydrogen | | | | | slight similarly to that of the hydrate of Test Example 1-8, but |
| | phosphate | | | | | the effect of suppressing deterioration over time is not |
| | (anhydrous) | | | | | observed as much as that of the hydrate. |
| 1-8 | Calcium | Good | Excellent | Excellent | Excellent | Texture is only slightly harder, and the difference is slight. |
| | monohydrogen | | | | | Flavor is slightly weakened but generally good. There is the |
| | phosphate | | | | | effect of suppressing discoloration over time, and texture |
| | (dihydrate) | | | | | without surface hardness and with sticky core is obtained, |
| | | | | | | so that deterioration is suppressed. |
| 1-9 | Calcium | Poor | Good | Good | Poor | The dihydrogen form affects flavor differently from the |
| | dihydrogen | | | | | monohydrogen forms of Test Examples 1-7 and 1-8. Effect of |
| | phosphate | | | | | suppressing discoloration over time is observed, but change of |
| | | | | | | texture over time cannot be suppressed. |
| 1-10 | Tricalcium | Good | Good | Poor | Poor | Impact of the hydrogen-free form on texture and flavor is |
| | phosphate | | | | | small similarly to those of the monohydrogen forms of |
| | | | | | | Test examples 1-7 and 1-8, but effect of suppressing change |
| | | | | | | over time is not observed differently from the monohydrogen |
| | | | | | | hydrate of Test Example 1-8. |
| 1-11 | Calcium | Poor | Good | Good | Poor | Impact on texture is small, but impact on flavor is strong. |
| | dihydrogen | | | | | Effect of suppressing discoloration over time is observed, but |
| | pyrophosphate | | | | | change of texture over time cannot be suppressed. |
| 1-12 | Calcium | Poor | Good | Poor | Poor | Impact on texture is small, but impact on flavor is strong. |
| | lactate | | | | | Effect of suppressing change over time is not observed. |
| 1-13 | Calcium | Fair | Good | Poor | Poor | Impact on texture is small, but impact on flavor is observed. |
| | gluconate | | | | | Effect of suppressing change over time is not observed. |

From the results of Experiment 1, it has been found that calcium monohydrogen phosphate hydrate is particularly excellent as a substance having a small impact on the texture and flavor and capable of suppressing discoloration and texture deterioration over time.

<Experiment 2> Relationship Between Calcium Monohydrogen Phosphate Hydrate and Kansui (Sodium Carbonate And Potassium Carbonate)

### Test Example 2-1

To 1 kg of a main raw material powder composed of 1000 g of all-purpose flour, kneading water obtained by dissolving 15 g of salt and 5 g of a kansui preparation (sodium carbonate 6:potassium carbonate 4) in 350 g of water was added, and they were kneaded with a normal pressure mixer for 15 minutes, thereby preparing a dough.

The dough prepared was compounded to prepare a noodle belt, and the noodle belt was aged for 15 minutes, then rolled out to 1.1 mm by a rolling method, and cut with a No. 22 round roll cutting blade, thereby preparing noodle strings.

Subsequently, the noodle strings prepared were steamed for 2 minutes 15 seconds in a steam chamber adjusted in such a manner that the flow rate of saturated steam became 240 kg/h, thereafter the steamed noodles were folded in half, and the noodles of 117 g for one meal were packed in a stainless steel drying container (retainer) of a box type.

The noodles packed in the retainer were dried with hot air at 85° C. and an air velocity of 1 m/s for 60 minutes.

The dried non-fried Chinese noodles were sealed in aluminum-deposited polypropylene bags, thereby preparing test samples (instant bag noodles). As test samples, a sample stored in a 4° C. refrigerator immediately after the preparation (before forced deterioration) and a sample subjected to forced deterioration under the constant temperature and humidity conditions of 40° C. and a humidity of 75% for 2 weeks (after forced deterioration) were prepared, and they were each used as an evaluation sample for the test section.

### Test Example 2-2

An evaluation sample was prepared in accordance with the method of Test Example 2-1, except that 2 g of calcium monohydrogen phosphate hydrate was added to the main raw material powder, and they were subjected to powder mixing.

### Test Example 2-3

An evaluation sample was prepared in accordance with the method of Test Example 2-1, except that 5 g of calcium monohydrogen phosphate hydrate was added to the main raw material powder, and they were subjected to powder mixing

### Test Example 2-4

An evaluation sample was prepared in accordance with the method of Test Example 2-1, except that 10 g of calcium monohydrogen phosphate hydrate was added to the main raw material powder, and they were subjected to powder mixing.

### Test Example 2-5

An evaluation sample was prepared in accordance with the method of Test Example 2-1, except that 15 g of calcium monohydrogen phosphate hydrate was added to the main raw material powder, and they were subjected to powder mixing.

### Test Example 2-6

An evaluation sample was prepared in accordance with the method of Test Example 2-1, except that the addition amount of the kansui preparation was changed to 10 g.

### Test Example 2-7

An evaluation sample was prepared in accordance with the method of Test Example 2-6, except that 6 g of calcium monohydrogen phosphate hydrate was added to the main raw material powder, and they were subjected to powder mixing.

### Test Example 2-8

An evaluation sample was prepared in accordance with the method of Test Example 2-6, except that 11 g of calcium monohydrogen phosphate hydrate was added to the main raw material powder, and they were subjected to powder mixing.

### Test Example 2-9

An evaluation sample was prepared in accordance with the method of Test Example 2-6, except that 20 g of calcium monohydrogen phosphate hydrate was added to the main raw material powder, and they were subjected to powder mixing.

### Test Example 2-10

An evaluation sample was prepared in accordance with the method of Test Example 2-6, except that 30 g of calcium monohydrogen phosphate hydrate was added to the main raw material powder, and they were subjected to powder mixing.

### Test Example 2-11

An evaluation sample was prepared in accordance with the method of Test Example 2-1, except that the addition amount of the kansui preparation was changed to 15 g.

### Test Example 2-12

An evaluation sample was prepared in accordance with the method of Test Example 2-11, except that 10 g of calcium monohydrogen phosphate hydrate was added to the main raw material powder, and they were subjected to powder mixing.

### Test Example 2-13

An evaluation sample was prepared in accordance with the method of Test Example 2-11, except that 20 g of calcium monohydrogen phosphate hydrate was added to the main raw material powder, and they were subjected to powder mixing.

### Test Example 2-14

An evaluation sample was prepared in accordance with the method of Test Example 2-11, except that 30 g of calcium monohydrogen phosphate hydrate was added to the main raw material powder, and they were subjected to powder mixing.

### Test Example 2-15

An evaluation sample was prepared in accordance with the method of Test Example 2-11, except that 40 g of calcium monohydrogen phosphate hydrate was added to the main raw material powder, and they were subjected to powder mixing.

The colors of the evaluation samples were evaluated as follows. A difference in color between the samples before and after forced deterioration was visually confirmed to carry out evaluation of the discoloration suppression effect, and in addition, the value a was measured by a colorimeter (manufactured by KONICA MINOLTA, INC., model number CR-410), then a difference between before and after deterioration was measured, and whether the discoloration was suppressed as a numerical value was confirmed. The discoloration level varies depending on the addition amount of kansui, and therefore, to evaluate the discoloration suppression visually, each of the evaluation samples of Test Example 2-1, Test Example 2-6 or Test Example 2-11 before and after deterioration was used as a reference, and the discoloration suppression effect of a sample containing the same addition amount of kansui was evaluated. A sample having no discoloration suppression effect as compared with the reference was evaluated as Poor, a sample in which a discoloration suppression effect was observed but the effect was weak was evaluated as Fair, a sample in which a discoloration suppression effect was observed and the effect was good was evaluated as Good, and a sample hardly suffering discoloration and having a very good discoloration suppression effect was evaluated as Excellent.

To evaluate the texture and flavor of the test sample, the samples before and after forced deterioration were each cooked in 500 ml of boiling water for 3 minutes, then powdered soup for Soy Sauce Ramen was added, and the samples were eaten and evaluated.

For the flavor, the sample before forced deterioration was evaluated. The flavor varies depending on the addition amount of kansui, and therefore, each of the evaluation samples of Test Example 2-1, Test Example 2-6 and Test Example 2-11 before forced deterioration was used as a reference, and the flavor of a sample containing the same addition amount of kansui was evaluated. A sample whose flavor was nearly equal to that of the reference was evaluated as Excellent, a sample whose flavor was inferior to that of the reference but was good was evaluated as Good, a sample whose flavor was inferior to and weaker than that of the reference but was felt was evaluated as Fair, and a sample having no flavor at all was evaluated as Poor.

For the texture, the samples before and after forced deterioration were evaluated. The texture varies depending on the addition amount of kansui, and therefore, each of the samples of Test Example 2-1, Test Example 2-6 and Test Example 2-11 before deterioration was used as a reference, and the texture of a sample containing the same addition amount of kansui was evaluated. A sample whose texture was very good equally to that of the reference sample was evaluated as Excellent, a sample whose texture was inferior to that of the reference sample but was generally good was evaluated as Good, a sample whose texture was inferior to that of the reference sample was evaluated as Fair, and a sample whose texture was markedly inferior to that of the reference sample was evaluated as Poor.

The evaluation results are set forth in the following Table 2.

TABLE 2

| | | Calcium | | | | | | | |
|---|---|---|---|---|---|---|---|---|---|
| | | monohydrogen | | | | | | | |
| | Kansui | phosphate | Color | | | | | | |
| | g/1 kg of | g/1 kg of | | | Difference | | | | |
| | main raw | main raw | | | between | | | Texture | |
| Test | material | material | Value a before | Value a after | before and after | Discoloration | Flavor before | Before | After |
| section | powder | powder | deterioration | deterioration | deterioration | suppression | deterioration | deterioration | deterioration |
| 2-1 | 5 | 0 | −3.12 | −0.08 | 3.04 | Reference | Reference | Reference | Fair |
| | | | | | | (Poor) | (Excellent) | (Excellent) | |
| 2-2 | 5 | 2 | −3.00 | −0.87 | 2.13 | Good | Excellent | Excellent | Good |
| 2-3 | 5 | 5 | −2.67 | −1.06 | 1.61 | Good | Good | Excellent | Excellent |
| 2-4 | 5 | 10 | −2.33 | −1.98 | 0.35 | Excellent | Good | Excellent | Excellent |
| 2-5 | 5 | 15 | −1.58 | −1.91 | −0.33 | Excellent | Fair | Fair | Good |
| 2-6 | 10 | 0 | −2.13 | 1.85 | 3.98 | Reference | Reference | Reference | x |
| | | | | | | (Poor) | (Excellent) | (Excellent) | |
| 2-7 | 10 | 6 | −2.58 | 0.34 | 2.92 | Fair | Excellent | Excellent | Good |
| 2-8 | 10 | 11 | −2.55 | −0.63 | 1.92 | Good | Good | Excellent | Excellent |
| 2-9 | 10 | 20 | −2.60 | −1.23 | 1.37 | Excellent | Good | Excellent | Excellent |
| 2-10 | 10 | 30 | −2.15 | −1.73 | 0.42 | Excellent | Fair | Fair | Good |
| 2-11 | 15 | 0 | −2.14 | 2.19 | 4.33 | Reference | Reference | Reference | x |
| | | | | | | (Poor) | (Excellent) | (Excellent) | |
| 2-12 | 15 | 10 | −2.87 | 1.22 | 4.09 | Fair | Excellent | Excellent | Good |
| 2-13 | 15 | 20 | −2.89 | 0.19 | 3.08 | Good | Good | Excellent | Excellent |
| 2-14 | 15 | 30 | −2.96 | −1.01 | 1.95 | Good | Good | Excellent | Excellent |
| 2-15 | 15 | 40 | −2.85 | −1.84 | 1.01 | Excellent | Fair | Fair | Good |

As shown in Experiment 2, a preferred addition amount of calcium monohydrogen phosphate hydrate varies depending on the addition amount of kansui, and therefore, the results of Experiment 2 will be described for each addition amount of kansui.

In the case where the addition amount of kansui was 5 g based on 1 kg of the main raw material powder, the discoloration suppression effect was observed as the addition amount of the calcium monohydrogen phosphate hydrate was increased, as shown in Test Example 2-1 to Test Example 2-5. Value a measured by the colorimeter is a value indicating a reddish tinge, and as the value increases, the reddish tinge becomes stronger. As can be seen from a difference in the analytical value between before and after forced deterioration, by adding calcium monohydrogen phosphate hydrate, the difference in value a between before and after deterioration was reduced, and therefore, the deterioration was suppressed. From the above, it is thought that by adding calcium monohydrogen phosphate hydrate in an amount of 2 g or more based on 1 kg of the main raw material powder, a good effect of suppressing discoloration over time can be obtained.

In the case where the addition amount of kansui was 5 g based on 1 kg of the main raw material powder, it was found that as the addition amount of the calcium monohydrogen phosphate hydrate was increased, the kansui odor was weakened, as shown in Test Example 2-1 to Test Example 2-5. When the addition amount of the calcium monohydrogen phosphate became 15 g based on 1 kg of the main raw material powder, the kansui odor was weakened and the flavor was deteriorated, and therefore, it is thought that in terms of flavor, the calcium monohydrogen phosphate hydrate is preferably added in an amount of 10 g or less based on 1 kg of the main raw material powder.

In the case where the addition amount of kansui was 5 g based on 1 kg of the main raw material powder, the texture before deterioration tended to become slightly harder as the addition amount of calcium monohydrogen phosphate hydrate was increased, as shown in Test Examples 2-2 to 2-4, but as shown in Test Example 2-5, when the addition amount of the calcium monohydrogen phosphate hydrate was too large, the texture rapidly became soft to the contrary. As the addition amount of calcium monohydrogen phosphate hydrate was increased, texture after deterioration such as surface hardening and non-sticky core was improved, and texture maintaining surface softness and core stickiness was obtained, as shown in Test Example 2-1 to Test Example 2-4. In Test Example 2-5, the texture turned a little harder after deterioration than the soft texture before deterioration, and the texture became good as a whole. From the above results, it is thought that in terms of obtaining a good effect of suppressing texture deterioration over time, the calcium monohydrogen phosphate hydrate is preferably added in an amount of 2 g or more based on 1 kg of the main raw material powder. It is thought that taking into consideration an impact of addition of the calcium monohydrogen phosphate hydrate on the texture, the calcium monohydrogen phosphate hydrate is preferably added in an amount of 10 g or less based on 1 kg of the main raw material powder.

In the case where the addition amount of kansui was 10 g based on 1 kg of the main raw material powder, as the addition amount of calcium monohydrogen phosphate hydrate was increased, the discoloration suppression effect was observed as in the case where the addition amount of kansui was 5 g based on 1 kg of the main raw material powder, as shown in Test Example 2-6 to Test Example 2-10. However, because of a large addition amount of kansui, the degree of discoloration over time was high, and as shown in Test Example 2-7, in the test section where calcium monohydrogen phosphate hydrate was added in an amount of 6 g based on 1 kg of the main raw material powder, the discoloration suppression effect was slight, but as shown in Test Example 2-8, in the test section where calcium monohydrogen phosphate hydrate was added in an amount of 11 g based on 1 kg of the main raw material powder, the discoloration suppression effect was improved. From the above, it is thought that in terms of obtaining a good effect of suppressing discoloration over time, the calcium monohydrogen phosphate hydrate is preferably added in an amount of 11 g or more based on 1 kg of the main raw material powder.

In the case where the addition amount of kansui was 10 g based on 1 kg of the main raw material powder, it was found that as the addition amount of the calcium monohydrogen phosphate hydrate was increased, the kansui odor was weakened as in the case where the addition amount of kansui was 5 g based on 1 kg of the main raw material powder, as shown in Test Example 2-6 to Test Example 2-10. When the addition amount of calcium monohydrogen phosphate hydrate became 30 g based on 1 kg of the main raw material powder, the kansui odor was weakened and the flavor was deteriorated, and therefore, it is thought that in terms of flavor, the calcium monohydrogen phosphate hydrate is preferably added in an amount of 20 g or less based on 1 kg of the main raw material powder.

In the case where the addition amount of kansui was 10 g based on 1 kg of the main raw material powder, when the addition amount of calcium monohydrogen phosphate hydrate was too large, the texture rapidly became soft as in Test Example 2-5, as shown in Test Example 2-10. As for the texture after deterioration, when the addition amount of kansui was large, texture deterioration such as surface hardening and non-sticky core was stronger as compared with Test Example 2-1, as shown in Test Example 2-6, but as shown in Test Example 2-7 to Test Example 2-9, as the addition amount of calcium monohydrogen phosphate hydrate was increased, the texture after deterioration was improved, and texture maintaining surface softness and core stickiness was obtained. Also in Test Example 2-10, the texture turned a little harder after deterioration than the soft texture before deterioration, and the texture became good as a whole as in Test Example 2-5. From the above results, it is thought that in terms of obtaining a good effect of suppressing texture deterioration over time, the calcium monohydrogen phosphate hydrate is preferably added in an amount of 6 g or more based on 1 kg of the main raw material powder. It is thought that taking into consideration an impact of addition of calcium monohydrogen phosphate hydrate on the texture, the calcium monohydrogen phosphate hydrate is preferably added in an amount of 20 g or less based on 1 kg of the main raw material powder.

In the case where the addition amount of kansui was 15 g based on 1 kg of the main raw material powder, as the addition amount of calcium monohydrogen phosphate hydrate was increased, the discoloration suppression effect was observed as in the case where the addition amount of kansui was 5 g or 10 g based on 1 kg of the main raw material powder, as shown in Test Example 2-11 to Test Example 2-15. However, because of a large addition amount of kansui, the degree of discoloration over time was high, and as shown in Test Example 2-12, in the test section where calcium monohydrogen phosphate hydrate was added in an amount of 10 g based on 1 kg of the main raw material powder, the discoloration suppression effect was slight, but as shown in Test Example 2-13, in the test section where calcium monohydrogen phosphate hydrate was added in an amount of 20 g based on 1 kg of the main raw material powder, the discoloration suppression effect was improved. From the above, it is thought that in terms of obtaining a good effect of suppressing discoloration over time, the calcium monohydrogen phosphate hydrate is preferably added in an amount of 20 g or more based on 1 kg of the main raw material powder.

In the case where the addition amount of kansui was 15 g based on 1 kg of the main raw material powder, it was found that as the addition amount of calcium monohydrogen phosphate hydrate was increased, the kansui odor was weakened as in the case where the addition amount of kansui was 5 g or 10 g based on 1 kg of the main raw material powder, as shown in Test Example 2-11 to Test Example 2-15. When the addition amount of calcium monohydrogen phosphate hydrate became 40 g based on 1 kg of the main raw material powder, the kansui odor was weakened and the flavor was deteriorated, and therefore, it is thought that in terms of flavor, the calcium monohydrogen phosphate hydrate is preferably added in an amount of 30 g or less based on 1 kg of the main raw material powder.

In the case where the addition amount of kansui was 15 g based on 1 kg of the main raw material powder, when the addition amount of calcium monohydrogen phosphate hydrate became too large, the texture rapidly became soft as in Test Example 2-5 or Test Example 2-10, as shown in Test Example 2-15. As shown in Test Example 2-11, when the addition amount of kansui was large, texture deterioration over time such as surface hardening and non-sticky core was stronger as compared with Test Example 2-1 or Test Example 2-6, but as shown in Test Example 2-12 to Test Example 2-14, as the addition amount of calcium monohydrogen phosphate hydrate was increased, the texture after deterioration was improved, and texture maintaining surface softness and core stickiness was obtained. Also in Test Example 2-15, the texture turned a little harder after deterioration than the soft texture before deterioration, and the texture became good as a whole as in Test Example 2-5 or Test Example 2-10. From the above results, it is thought that in terms of obtaining a good effect of suppressing texture deterioration over time, the calcium monohydrogen phosphate hydrate is preferably added in an amount of 10 g or more based on 1 kg of the main raw material powder. It is thought that taking into consideration an impact of addition of calcium monohydrogen phosphate hydrate on the texture, the calcium monohydrogen phosphate hydrate is preferably added in an amount of 30 g or less based on 1 kg of the main raw material powder.

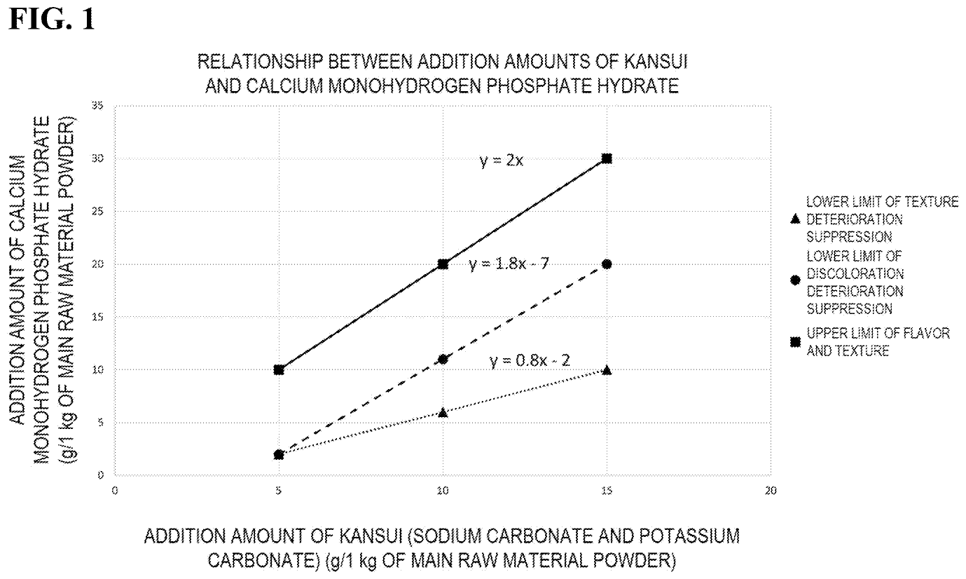

To summarize the results of Test Example 2-1 to Test Example 2-15, it has been found that when the addition amount (g) of kansui based on 1 kg of the main raw material powder is represented by X and the addition amount (g) of calcium monohydrogen phosphate hydrate is represented by Y, the addition amount (Y) of the calcium monohydrogen phosphate hydrate relative to the addition amount (X) of kansui is preferably adjusted in such a way that Y≥0.8X−2, in terms of obtaining a good effect of suppressing texture deterioration over time, as shown in the following Table 3 and FIG. 1.

It has been found that in terms of obtaining good flavor and texture, the addition amount (Y) of the calcium monohydrogen phosphate hydrate relative to the addition amount (X) of kansui is preferably adjusted in such a way that

It has been found that in terms of obtaining a good effect of suppressing discoloration over time, the addition amount (Y) of the calcium monohydrogen phosphate hydrate relative to the addition amount (X) of kansui is preferably adjusted in such a way that Y≥1.8X−7.

From the above, the addition amount (X) of kansui (sodium carbonate and potassium carbonate) and the addition amount (Y) of calcium monohydrogen phosphate hydrate in the non-fried Chinese noodles according to the present invention are preferably adjusted so as to be in the range of the following expression (1), more preferably the following expression (2). 0.8X−2≤Y≤2X . . . (Expression 1), 1.8X−7≤Y≤2X . . . (Expression 2) wherein X represents an addition amount (g) of sodium carbonate and/or potassium carbonate based on 1 kg of a main raw material powder, and Y represents an addition amount (g) of calcium monohydrogen phosphate hydrate based on 1 kg of a main raw material powder.

TABLE 3

| | Kansui 5 g | Kansui 10 g | Kansui 15 g |
|---|---|---|---|
| Minimum addition amount (g) of calcium monohydrogen | 2 | 6 | 10 |
| phosphate hydrate for obtaining good effect of | | | |
| suppressing texture | | | |
| Minimum addition amount (g) of calcium monohydrogen | 2 | 11 | 20 |
| phosphate hydrate for obtaining good effect of | | | |
| suppressing discoloration | | | |
| Maximum addition amount (g) of calcium monohydrogen | 10 | 20 | 30 |
| phosphate hydrate for obtaining non-fried Chinese | | | |
| noodles having good flavor and texture | | | |

<Experiment 3> Study of Three-Layer Structure

### Test Example 3-1

To 1 kg of a main raw material powder composed of 800 g of all-purpose flour and 200 g of acetylated tapioca starch, kneading water obtained by dissolving 20 g of salt, 7 g of a kansui preparation (sodium carbonate 6:potassium carbonate 4) and 0.5 g of marigold pigment in 400 g of water was added, and they were kneaded with a normal pressure mixer for 15 minutes, thereby preparing a dough for inner and outer layer noodle belts.

The dough for inner and outer layer noodle belts prepared was compounded to prepare an outer layer noodle belt and an inner layer noodle belt, then the outer layer noodle belt was rolled out in such a manner that the thickness thereof became half the thickness of the inner layer noodle belt, and while interposing the inner layer noodle belt between two outer layer noodle belts, they were passed through shaping rolls, thereby preparing a three-layer noodle belt. Subsequently, the three-layer noodle belt was aged for 15 minutes, thereafter the noodle belt was rolled out to 1.1 mm by a rolling method, and the resulting noodle belt was cut with a No. 16 square roll cutting blade, thereby preparing noodle strings.

Subsequently, the noodle strings prepared were steamed for 2 minutes in a steam chamber adjusted in such a manner that the flow rate of saturated steam became 240 kg/h, then dipped for 5 seconds in a liquid seasoning containing 10 g of salt and 5 g of gum arabic per liter dissolved therein, and cut to about 30 cm, and thereafter, noodles of 140 g for one meal were packed in a stainless steel drying container (retainer) in approximately deep dish shape.

The noodles packed in the retainer were dried with hot air at 70° C. and an air velocity of 3 m/s for 60 minutes.

The dried non-fried Chinese noodles were placed in an expanded polystyrene cup, and the cup was sealed with a lid made of paper covered with aluminum, thereby preparing a test sample (instant cup noodles). As test samples, a sample stored in a 4° C. refrigerator immediately after the preparation (before forced deterioration) and a sample subjected to forced deterioration under the constant temperature and humidity conditions of 40° C. and a humidity of 75% for 2 weeks (after forced deterioration) were prepared, and they were each evaluated by confirming sample appearance and texture.

### Test Example 3-2

To a powder obtained by subjecting 1 kg of a main raw material powder composed of 800 g of all-purpose flour and 200 g of acetylated tapioca starch and 7 g of calcium monohydrogen phosphate hydrate to powder mixing, kneading water obtained by dissolving 20 g of salt and 7 g of a kansui preparation (sodium carbonate 6:potassium carbonate 4) in 400 g of water was added, and they were kneaded with a normal pressure mixer for 15 minutes, thereby preparing a dough for inner and outer layer noodle belts.

The dough for inner and outer layer noodle belts prepared was compounded to prepare an outer layer noodle belt and an inner layer noodle belt, then the outer layer noodle belt was rolled out in such a manner that the thickness thereof became half the thickness of the inner layer noodle belt, and while interposing the inner layer noodle belt between two outer layer noodle belts, they were passed through shaping rolls, thereby preparing a three-layer noodle belt. Subsequently, the three-layer noodle belt was aged for 15 minutes, thereafter the noodle belt was rolled out to 1.1 mm by a rolling method, and the resulting noodle belt was cut with a No. 16 square roll cutting blade, thereby preparing noodle strings.

The subsequent operations were carried out in accordance with those in Test Example 3-1, thereby preparing evaluation samples.

### Test Example 3-3

To a powder obtained by subjecting 1 kg of a main raw material powder composed of 800 g of all-purpose flour and 200 g of acetylated tapioca starch and 14 g of calcium monohydrogen phosphate hydrate to powder mixing, kneading water obtained by dissolving 20 g of salt and 7 g of a kansui preparation (sodium carbonate 6:potassium carbonate 4) in 400 g of water was added, and they were kneaded with a normal pressure mixer for 15 minutes, thereby preparing a dough for an inner layer noodle belt.

To 1 kg of a main raw material powder composed of 800 g of all-purpose flour and 200 g of acetylated tapioca starch, kneading water obtained by dissolving 20 g of salt and 7 g of a kansui preparation (sodium carbonate 6:potassium carbonate 4) in 400 g of water was added, and they were kneaded with a normal pressure mixer for 15 minutes, thereby preparing dough for an outer layer noodle belt.

The doughs for inner layer and outer layer noodle belts prepared were compounded to prepare an inner layer noodle belt and an outer layer noodle belt, then the outer layer noodle belt was rolled out in such a manner that the thickness thereof became half the thickness of the inner layer noodle belt, and while interposing the inner layer noodle belt between two outer layer noodle belts, they were passed through shaping rolls, thereby preparing a three-layer noodle belt. Subsequently, the three-layer noodle belt was aged for 15 minutes, thereafter the noodle belt was rolled out to 1.1 mm by a rolling method, and the resulting noodle belt was cut with a No. 16 square roll cutting blade, thereby preparing noodle strings.

The subsequent operations were carried out in accordance with those in Test Example 3-1, thereby preparing evaluation samples.

The colors of the evaluation samples were evaluated as in Experiment 2. A difference in color between the samples before and after forced deterioration was visually confirmed to evaluate the discoloration suppression effect, and in addition, the value a was measured by a colorimeter (manufactured by KONICA MINOLTA, INC., model number CR-410), then a difference between before and after deterioration was measured, and whether the discoloration was suppressed as a numerical value was confirmed. The discoloration suppression evaluation by visual observation was carried out by using the evaluation sample of Test Example 3-1 as a reference. A sample having no discoloration suppression effect as compared with the reference was evaluated as Poor, a sample in which discoloration suppression effect was observed but the effect was weak was evaluated as Fair, a sample in which discoloration suppression effect was observed and the effect was good was evaluated as Good, and a sample hardly suffering discoloration and having a very good discoloration suppression effect was evaluated as Excellent.

To evaluate the texture and flavor of the test sample, to respective samples before forced deterioration and after forced deterioration, 480 ml of boiling water was added, the samples were cooked for 5 minutes, then liquid soup for Soy Sauce Ramen was added, and the samples were eaten.

For the flavor, the sample before forced deterioration was evaluated, and the evaluation sample of Test Example 3-1 before forced deterioration was used as a reference. A sample whose flavor was nearly equal to that of the reference was evaluated as Excellent, a sample whose flavor was inferior to that of the reference but was good was evaluated as Good, a sample whose flavor was inferior to and weaker than that of the reference but was felt was evaluated as Fair, and a sample having no flavor at all was evaluated as Poor.

For the texture, the samples before forced deterioration and after forced deterioration were evaluated, and the sample of Test Example 3-1 before deterioration was used as a reference. A sample whose texture was very good equally to that of the reference sample was evaluated as Excellent, a sample whose texture was inferior to that of the reference sample but was generally good was evaluated as Good, a sample whose texture was inferior to that of the reference sample was evaluated as Fair, and a sample whose texture was markedly inferior to that of the reference sample was evaluated as Poor.

The evaluation results are set forth in the following Table 3.

TABLE 4

| | Kansui | Calcium | | | | | | | | |
|---|---|---|---|---|---|---|---|---|---|---|
| | (inner and | monohydrogen | | | | | | | | |
| | outer) | phosphate | | Color | | | | | | |
| | g/1 kg of | g/1 kg of main raw | | | | Difference | | | | |
| | main raw | material powder | | | | between | | | Texture | |
| Test | material | Outer | Inner | Value a before | Value a after | before and after | Discoloration | Flavor before | Before | After |
| section | powder | layer | layer | deterioration | deterioration | deterioration | suppression | deterioration | deterioration | deterioration |
| 3-1 | 7 | 0 | 0 | −1.12 | 0.20 | 1.32 | Reference | Reference | Reference | Poor |
| | | | | | | | (Poor) | (Excellent) | (Excellent) | |
| 3-2 | 7 | 7 | 7 | −1.12 | −1.14 | −0.02 | Excellent | Good | Excellent | Excellent |
| 3-3 | 7 | 0 | 14 | −1.25 | −1.14 | 0.11 | Excellent | Good | Excellent | Excellent |

As shown in Experiment 3, it can be seen that also in the three-layer noodle belt, deterioration over time was suppressed by adding calcium monohydrogen phosphate hydrate. Color differentiation was difficult from the values obtained by the colorimeter because the pigment was added, but as shown in Test Examples 3-2 and 3-3, there was no difference in the discoloration suppression effect between the case where calcium monohydrogen phosphate hydrate was homogeneously added to the whole of the inner and outer layers and the case where it was added to only the inner layer.

The flavor was felt slightly weaker by adding calcium monohydrogen phosphate hydrate, but no difference in flavor was felt between Test Example 3-2 and Test Example 3-3.

As for the texture, in Test Example 3-2 containing calcium monohydrogen phosphate hydrate in the outer layer, the surface before deterioration was slightly harder as compared with that of Test Example 3-1 or Test Example 3-3. As for the texture after deterioration, Test Example 3-1 provided a texture of hard surface and non-sticky core, while Test Example 3-2 and Test Example 3-3 provided a nearly equivalent texture, and a soft surface and a sticky core without deterioration being felt.

From the above results, it can be seen that when calcium monohydrogen phosphate hydrate is added to noodles of multilayer structure, it may be homogeneously added to the inner layer and the outer layers or may be added to only the inner layer.

1. Non-fried Chinese noodles comprising a noodle raw material, sodium carbonate and/or potassium carbonate, and calcium monohydrogen phosphate hydrate.

2. The non-fried Chinese noodles according to claim 1, wherein an addition amount of the sodium carbonate and/or potassium carbonate and an addition amount of the calcium monohydrogen phosphate hydrate satisfy the following expression 1:
0.8X−2≤Y≤2X (Expression 1)
wherein X represents the addition amount (g) of the sodium carbonate and/or potassium carbonate based on 1 kg of a main raw material powder, and Y represents the addition amount (g) of the calcium monohydrogen phosphate hydrate based on 1 kg of the main raw material powder.

3. The non-fried Chinese noodles according to claim 1, wherein the addition amount of the sodium carbonate and/or potassium carbonate and the addition amount of the calcium monohydrogen phosphate hydrate satisfy the following expression 2:
1.8X−7≤Y≤2X (Expression 2)
wherein X represents the addition amount (g) of the sodium carbonate and/or potassium carbonate based on 1 kg of the main raw material powder, and Y represents the addition amount (g) of the calcium monohydrogen phosphate hydrate based on 1 kg of the main raw material powder.

4. The non-fried Chinese noodles according to claim 1, wherein the addition amount of the sodium carbonate and/or potassium carbonate is 5 to 15 g based on 1 kg of the main raw material powder.

5. A production method for non-fried Chinese noodles, comprising adding a kneading water containing sodium carbonate and/or potassium carbonate dissolved therein to a powder obtained by adding calcium monohydrogen phosphate hydrate to a main raw material powder and subjecting them to powder mixing, kneading the resultant with a mixer to prepare a noodle dough, and then carrying out noodle making, steaming and drying.

6. The production method for non-fried Chinese noodles according to claim 5, wherein an addition amount of the sodium carbonate and/or potassium carbonate and an addition amount of the calcium monohydrogen phosphate hydrate satisfy the following expression 1:
0.8X−2≤Y≤2X (Expression 1)
wherein X represents the addition amount (g) of the sodium carbonate and/or potassium carbonate based on 1 kg of the main raw material powder, and Y represents the addition amount (g) of the calcium monohydrogen phosphate hydrate based on 1 kg of the main raw material powder.

7. The production method for non-fried Chinese noodles according to claim 5, wherein the addition amount of the sodium carbonate and/or potassium carbonate and the addition amount of the calcium monohydrogen phosphate hydrate satisfy the following expression 2:
1.8X−7≤Y≤2X (Expression 2)
wherein X represents the addition amount (g) of the sodium carbonate and/or potassium carbonate based on 1 kg of the main raw material powder, and Y represents the addition amount (g) of the calcium monohydrogen phosphate hydrate based on 1 kg of the main raw material powder.

8. The production method for non-fried Chinese noodles according to claim 5, wherein the addition amount of the sodium carbonate and/or potassium carbonate is 5 to 15 g based on 1 kg of the main raw material powder.
